(19) United States
(12) Patent Application Publication
(10) Pub. No.: US 2005/0198643 A1
(43) Pub. Date: Sep. 8, 2005

(54) Journaling proxy in activation solution

(76) Inventors: David Jonathan Lachelt, Fort Collins, CO (US); Fredrick M. Roeling, Fort Collins, CO (US); Steve Jon Constant, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/780,516

(22) Filed: Feb. 17, 2004

(51) Int. Cl. G06F 9/46

(52) U.S. Cl. 718/106; 718/102

(57) ABSTRACT

An arrangement for activating a target element is disclosed. The arrangement includes an activation engine and a journaling proxy coupled to the activation engine and the target element. The journaling proxy is configured to receive an atomic request from the activation engine 1. The journaling proxy intentionally delays sending the atomic request to the target element for execution until a set of predefined configuration parameters for the target element is satisfied.

### BACKGROUND OF THE INVENTION

Activation engines have long been employed to provision or activate hardware and software elements in a computer or a computer network (referred to herein generically as a computing arrangement). In a given computing arrangement, an activation engine may be employed to receive a high level activation request pertaining to one or more target elements, which may be hardware or software devices or functions to be activated. The activation engine employs an internal algorithm to break down or parse the high level request into individual task requests to be sent to the different target elements. The individual tasks may then configure the target elements, thereby activating the desired functionality.

Hereafter these individual tasks will be referred to as “atomic tasks”. An atomic task is a configuration action on a hardware or software element that changes the state of the element. These atomic tasks are typically reversible, that is the action can be undone to set the state of the element back to what it was prior to the action. A high level request will typically break down into multiple atomic tasks addressed to one or more target elements. Each atomic task is sent to a single target element, and within a high level request multiple atomic tasks may be sent to the same target element.

By way of example, an activation engine may be employed to activate a web hosting service by provisioning or configuring a plurality of target elements such as a web hosting server, a DNS server, a database server, and the like. Generally speaking, the desired functionality (e.g., web hosting service for a particular customer) can be achieved only if all the target elements are properly configured. In other words, activation is only deemed successful if every target element has been configured in accordance with all of the atomic tasks addressed to it.

If the configuration for one of the target elements fails, e.g., due to a lack of memory or due to an improperly formatted atomic task request, it is typically necessary to return the computing arrangement to the state that existed prior to the activation attempt. If, for example, there are three target elements to be configured and the first two target elements configure successfully but the third target element fails the configuration attempt, it is typically necessary to undo the configuration of all three target elements associated with the activation attempt in order to return the computing arrangement back to the state that existed before the activation attempt.

Certain target elements may have constraints placed upon them with regard to configuration. For example, an increasingly common constraint is the time restriction placed on a particular target element. The time restriction may dictate, for example, that the target element can be configured only within a particular time window, e.g., one o'clock in the morning to three o'clock in the morning. The time restriction may be imposed on the target element in order to, for example, minimize disruptions to the computing arrangement at times of highest demand. If a high level activation request includes an atomic task request that requires the configuration of such a time-restricted target element, the entire activation attempt would fail unless the high level activation request happens to be received during the allowed time period. If the activation attempt fails, all target elements that have already been configured in accordance with their respective atomic tasks as part of the high level activation request must be undone, as mentioned earlier.

Another type of restriction that may be imposed on a target element relates to the resetting the target element. In many cases, the re-configuration of a particular target element requires the target element to be reset. Some of these computer elements may be quite complex and may therefore require a fairly lengthy amount of time to reset, e.g., up to a minute or more. If the target is reset every time configuration happens, it is possible that some target elements may spend a significant percentage of the time resetting itself after executing atomic tasks. In fact, it is possible for a target device to spend as much time, if not more, in performing resets as in doing actual work. As such, the performance of the target element may be unduly degraded.

### SUMMARY OF INVENTION

The invention relates, in an embodiment, to a method of activating a plurality of target elements in a computing arrangement. The method includes receiving a high-level activation request pertaining to the plurality of target elements. The method also includes parsing the high-level activation request into a plurality of atomic requests. The method additionally includes receiving at time t1 a first atomic request of the plurality of atomic requests at a first journaling proxy. The first journaling proxy is associated with a first target element of the plurality of target elements. The first journaling proxy intentionally delays sending the first atomic request to the first target element for execution until a time t2 that satisfies a set of predefined configuration parameters for the first target element.

The invention relates, in another embodiment, to an arrangement for activating a target element. The arrangement includes an activation engine and a journaling proxy coupled to the activation engine and the target element. The journaling proxy is configured to receive an atomic request from the activation engine at time t1. The journaling proxy intentionally delays sending the atomic request to the target element for execution until a time t2 that satisfies a set of predefined configuration parameters for the target element.

In yet another embodiment, the invention relates to an article of manufacture comprising a program storage medium having computer readable code embodied therein, the computer readable code being configured to activate a target element in a computing arrangement. There is included computer readable code for receiving an atomic request at a journaling proxy from an activation engine. There is also included computer readable code for intentionally delaying execution of the atomic request by the target element until a time that satisfies a set of predefined configuration parameters for the target element.

These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows, in a simplified diagram format, how an activation engine may be employed to configure a plurality of target elements.

FIG. 2 is a prior art diagram which illustrates, in a simplified state format, the various states that exist during an activation request attempt.

FIG. 3 shows, in accordance with an embodiment of the present invention, a block diagram of the improved arrangement for activating target elements using an activation engine and a journaling proxy.

FIG. 4 shows, in accordance with an embodiment of the present invention, a state diagram illustrating how a high level activation request may be serviced by the activation engine and the journaling proxy.

### DETAILED DESCRIPTION OF VARIOUS EMBODIMENTS

The present invention will now be described in detail with reference to a few various embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. For example, the various hardware components of a typical electronic system (e.g., CPUs, I/Os, memory, keyboard, mouse, optical or magnetic disks, etc.) and/or a typical network (e.g., sending node, receiving node, router, transmission medium, routers, bridges, hubs, etc.) are not discussed in details although they are considered parts of the invention if/when employed to practice the described method and/or algorithm.

Furthermore, one should keep in mind that the mechanism to execute each of the steps of the described method may be implemented in software and/or hardware. The hardware mechanism may be dedicated in the sense that there is a dedicated hardware logic portion to perform each step. The hardware mechanism may also be programmable in the sense that the same hardware circuitry may be programmed by different codes (e.g., software or firmware) in order to perform different steps of the method at different times. This is more typically the case with modern electronic circuitry, and it is intended that the claims cover both the dedicated hardware situation and the programmable hardware situation. It should be noted in particular that in the claims that follow herein, the same programmable logic (e.g., CPU, programmable array logic, flip-flops, and/or other programmable circuitry), when programmed by different codes to perform different functions at different times, would cover different mechanisms or means to accomplish the various steps of the method since the same programmable logic, while appearing visually unchanged, does indeed behave differently when programmed by different codes.

In accordance with embodiments of the invention, journaling proxies are interposed between the activation engine and selected target elements to intercept atomic task requests. Each journaling proxy acting on behalf of a particular target element preferably knows all the relevant configuration-related constraints of the target element. For target elements with configuration time constraints, the journaling proxy keeps track of the time window during which configuration is permissible. For a target element experiencing resetting inefficiencies, the journaling proxy associated therewith may execute its own algorithm to store up multiple configuration requests before executing them all in a batch and resetting the device only once. In this manner, all pending atomic task requests may be attempted during a valid time window and the time spent by the target element in resetting itself is reduced.

In an embodiment, after the journaling proxy accepts the element-level, atomic task request from the activation engine, the journaling proxy may validate the format of the atomic task request. The validation may include, for example, ascertaining whether the parameters specified are legal, whether the atomic task request can be fulfilled but for the configuration time constraint or the batch reset constraint. If it is determined that the atomic task request can be fulfilled but for these constraints, the journaling proxy then sends a qualified acknowledgement back to the activation engine, which signals to the activation engine that the atomic task has not failed but is merely delayed.

At the appropriate time, the journaling proxy then fulfills the atomic task request in a manner that does not violate the constraints imposed on the target elements. For a target element that has a configuration time constraint imposed on the permissible configuration time, the journaling proxy may intentionally delay the configuration until the time when configuration is permissible. For a target element that experiences inefficiency due to an excessive number of resets, the journaling proxy may save up atomic task requests until a configured number of requests have been reached or until a configured time has elapsed in order to execute multiple atomic tasks in a batch and to reset only once (or with fewer resets).

In an embodiment, the journaling proxy sends back a qualified acknowledgement only if there is a high degree of confidence that the atomic task request can eventually be fulfilled. For example, in addition to the above-discussed parameter validation, the journaling proxy may communicate with its associated target element to ascertain whether the target element is likely to be able to fulfill the request when the time comes for the journaling proxy to send the atomic task request onward.

In an embodiment, the activation engine may treat the qualified acknowledgement as a full acknowledgement due to the high level of confidence associated with the qualified acknowledgement. In another embodiment, the activation engine may treat the qualified acknowledgement only as a provisional acknowledgement and may wait until it receives the confirmation from the journaling proxy and/or from the target element.

Since the atomic task request is intercepted by the journaling proxy and therefore the configuration task associated with that atomic task request does not have a chance to fail due solely to the aforementioned constraints, the activation engine never receives a failure message from the target element simply due to the existence of the aforementioned constraints. Thus, there is no need to undo the successful configuration of the other target elements simply because one or more of the target elements in the set to be configured happen to have a configuration time constraint or a batch reset constraint. As far as the activation engine is concerned, the activation task is “completed” and the activation engine may turn its attention to other high level activation requests without having to expend its resources in undoing a high level activation request, which would have failed but for the intervention by the journaling proxy. When the time comes for the journaling proxy to execute the atomic task, the successful configuration will be reported by the target element and/or the journaling proxy, and the activation request is then considered fulfilled.

Of course there are cases when the journaling proxy may discover that the target element would be unable to fulfill the atomic task request anyway (e.g., due to incorrect request formatting or inadequate or unavailable resource at the target element). In these situations, the activation engine would receive a failure message, but such failure is of course not due solely to the existence of the aforementioned constraints.

Thus, there is no need to undo the successful configuration of the other target elements simply because one or more of the target elements in the set to be configured happen to have a configuration time constraint or a batch reset constraint. As far as the activation engine is concerned, the activation task is “completed” and the activation engine may turn its attention to other high level activation requests without having to expend its resources in undoing a high level activation request, which would have failed but for the intervention by the journaling proxy. When the time comes for the journaling proxy to execute the atomic task, the successful configuration will be reported by the target element and/or the journaling proxy, and the activation request is then considered fulfilled.

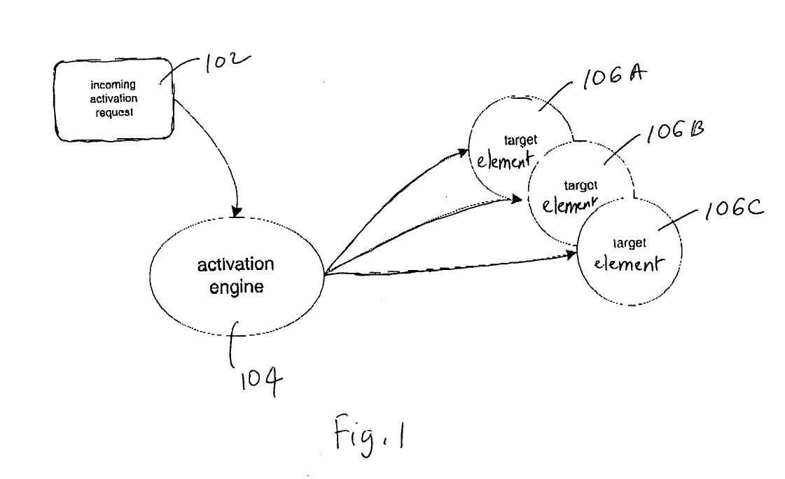

The features and advantages of the invention may be better understood with reference to the figures and discussions that follow. FIG. 1 shows, in a simplified diagram format, how an activation engine may be employed to configure a plurality of target elements. With reference to FIG. 1, an incoming high level activation request 102 is received by an activation engine 104 from a requester (not shown). Activation engine 104 may perform validation on the high-level request, including for example ensuring that the high level activation request has the proper parameters and format.

Furthermore, activation engine 104 parses the high level activation request into atomic task requests to forward to a plurality of target elements 106A, 106B, and 106C as shown. For example, if the high level activation request relates to enabling web hosting for a XYZ Shoe Store, activation engine 104 may parse the high level request into a plurality of atomic task requests that involve asking target element 106A to create a user “XYZ” on a UNIX server; configuring target element 106B to add a DNS entry into the DNS server; and configuring target element 106C as a web server.

As mentioned earlier, the failure of one of the target elements to configure itself in accordance with the received atomic task request would cause the activation attempt to fail in the prior art. Any target element that has already been configured using an atomic task request from that activation attempt would thus need to be undone in the prior art. For example, suppose target element 106A and target element 106B configure successfully (e.g., creating a user XYZ on a UNIX server and adding a DNS entry to the DNS server). When target element 106C attempts to act as web server, it fails due to insufficient disk space. Thus, target element 106C fails to configure in accordance with the received atomic task request. In this case, the prior art requires that the configuration of target elements 106A and 106B be undone in order to restore the computer arrangement back to the state that existed before the commencement of the activation attempt.

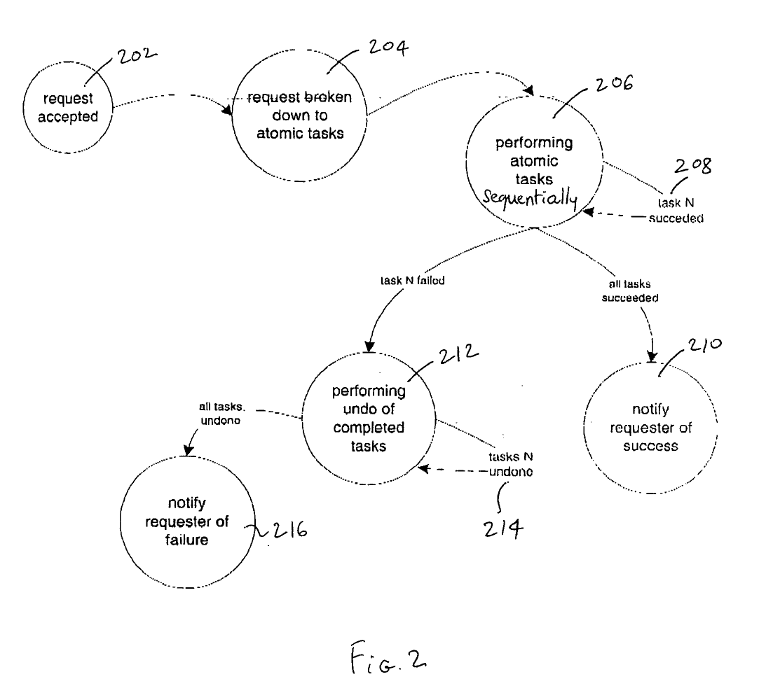

FIG. 2 illustrates, in a simplified state diagram format, the various states that exist during an activation request attempt. In state 202, the high level activation request is accepted by the activation engine. In state 204, the high level activation request is broken down to atomic task requests.

In state 204, the high level request is broken down into atomic task requests. In state 206, the atomic tasks are performed sequentially. The activation engine may evaluate whether each atomic task has succeeded (state 208) before the next atomic task is performed. If all atomic tasks are completed successfully, state 210 is entered wherein the requester is notified of the success of the high level activation request.

On the other hand, if one of the atomic tasks failed (as evaluated by the activation engine in state 208), the prior art requires the undoing of all completed atomic tasks (shown in state 212). The undoing of the completed atomic task may be supervised by the activation engine in state 214 to ensure that all completed atomic tasks are successfully undone. Once all the atomic tasks related to the received high level activation request are undone, state 216 is entered wherein the requester is notified of failure.

As mentioned earlier, the undoing of all completed tasks in state 212 represents an inefficient use of the activation engine resources since any one of the multiple atomic task requests may encounter the aforementioned time restriction or batch reset restriction.

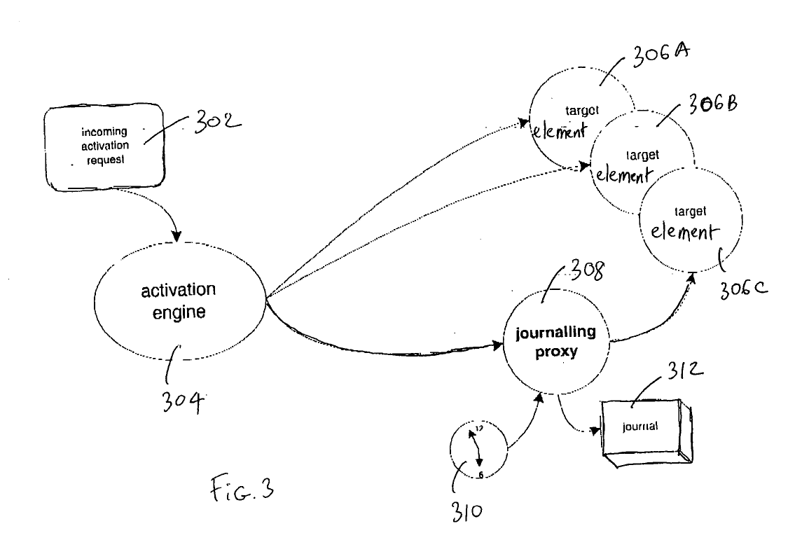

FIG. 3 shows, in accordance with an embodiment of the present invention, a block diagram of the improved arrangement for activating target elements using an activation engine and a journaling proxy. In FIG. 3, the high level activation request (302) is received at activation engine 304. As before, activation engine 304 may perform checks on the parameters and the format of the high level activation request.

Thereafter, activation engine 304 may parse the high level activation request into a plurality of atomic task requests to be sent to the target elements. In FIG. 3, target element 306A and 306B represent target elements without the aforementioned time restriction or batch reset restriction. However, target element 306C represents a target element that may have either a time restriction or a batch reset restriction. In this case, a journaling proxy is interposed between activation engine 304 and target element 306C.

In an embodiment, there is a journaling proxy for every target element that has one or more of the aforementioned constraints (e.g., configuration time constraint or batch reset constraint). However, it is possible to provide journaling proxies for only a subset of the target elements that have the aforementioned constraints. Journaling proxy 308 may be implemented by software to intercept atomic task requests sent from activation engine 304 to target element 306C. The software-implemented journaling proxy 308 may execute on the same server that runs activation engine 304 or, more preferably, on a server closer to target element 306C, perhaps even on the target element itself 306C. Journaling proxy 308 may be also implemented by hardware and/or a combination of hardware/software.

Journaling proxy 308 may perform further checks on the atomic task request received from activation engine 304 to ensure that the atomic task request received can be performed by target element 306C when the time comes. For example, journaling proxy 308 may evaluate the format and the parameters associated with the received atomic task request, using its knowledge of target element 306C. Journaling proxy 308 may also communicate with target element 306C to assess the status of target element 306C, again to ensure that target element 306C could perform the atomic task request if and when it receives the atomic task request from journaling proxy 308.

If target element 306C has a time restriction, journaling proxy 308 intentionally delays the execution of the atomic task until the pre-defined execution parameters for target element 306 are satisfied (e.g., until the permissible time window arrives). This is shown symbolically in FIG. 3 by the clock symbol 310, representing the time delay function of the journaling proxy.

On the other hand, if target element 306C has a batch reset restriction, journaling proxy 308 may intentionally delay execution of the atomic task until journaling proxy 308 has accumulated the required number of atomic task requests that involves resetting, or until a configured time has elapsed since the last reset. This is shown symbolically in FIG. 3 by the journal symbol 312, representing the accumulating function of the journaling proxy. The number of atomic requests to be accumulated or request frequency time may be user-defined, predefined, or programmable. In this manner, target element 306C may be configured by multiple atomic task requests and be reset only once (or with fewer resets).

In between the time that journaling proxy 308 receives the atomic task request from activation engine 304 and the time it forwards that atomic task request to target element 306C for execution, journaling proxy 308 may send a qualified acknowledgement to activation engine 304. As mentioned, activation engine 304 may deem the activation request to be temporarily delayed and may wait until it receives a confirmation at a later time from journaling proxy 308 and/or target element 306C before activation engine 304 deems the high level activation request completed. In this manner, even if target element 306C is not immediately configured and, in fact, would fail due to time restrictions if configuration is attempted immediately, activation engine 304 does not receive a failure notification and, therefore, does not require the configuration of target elements 306A and 306B to be undone.

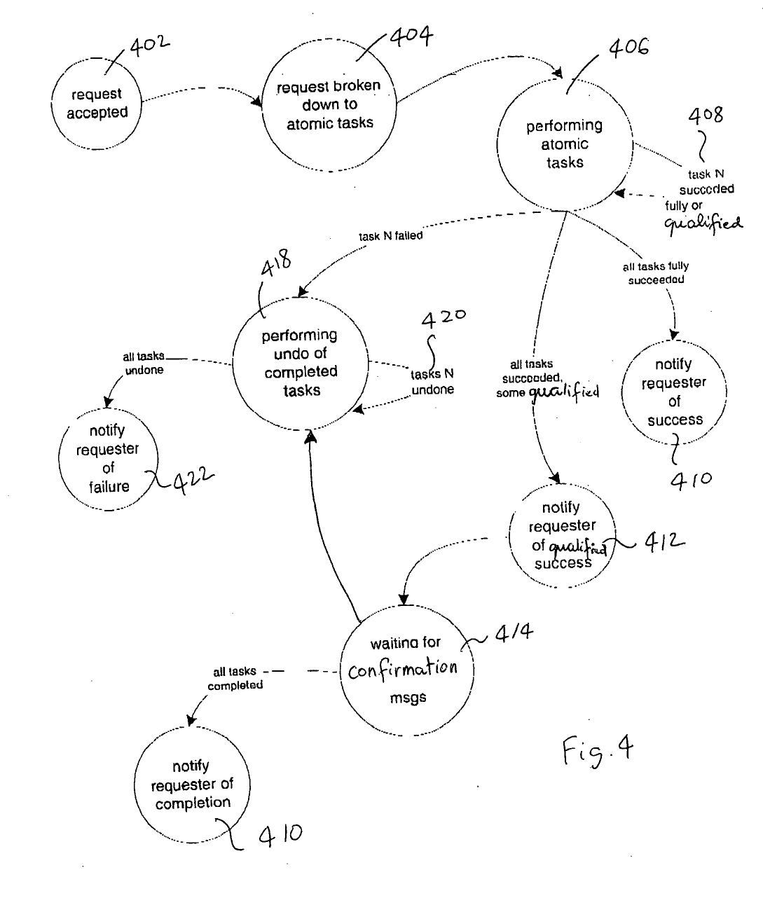

FIG. 4 shows, in accordance with an embodiment of the present invention, a state diagram illustrating how a high level activation request may be serviced by the activation engine and the journaling proxy. In state 402, the high level activation request is accepted by the activation engine. In state 404, the high level activation request is again broken down into a plurality of atomic task requests. The plurality of atomic tasks are performed in state 406, and activation engine 408 may supervise the execution of the atomic tasks in state 408 to ensure that each atomic task is successfully completed, either fully or in a qualified manner using the journaling proxy.

From this state 406, three possibilities exist. In the first case, all atomic tasks fully succeed (i.e., none of the tasks fail or complete in a qualified manner using the journaling proxy or proxies) and state 410 is entered. In this case, the activation engine would notify the requester that the high level activation request has been successfully performed.

In the second case, if all atomic tasks are successfully completed but some are completed in a qualified manner using journaling proxies, state 412 is entered whereby the activation engine may notify the requester that a qualified success is achieved. Thereafter, state 414 is entered wherein the activation engine and the requester wait for the confirmation message. If the delayed atomic task is successfully performed later, the confirmation is received and the requester is notified (state 416) when all the atomic tasks have successfully completed configuration in an unqualified manner.

If the activation engine receives a failure message from the target element indicating that the atomic task failed, a state 418 is entered. This situation may be encountered if, for example, the target element does not have sufficient resources to carry out the requested atomic task (once it is sent by the journaling proxy), or if a time-out is encountered. In this state 418, the previously completed atomic tasks that relate to the same high level activation request are undone. The undoing of the previously completed atomic tasks may be supervised by the activation engine in state 420. Once all the atomic tasks related to the failed high level activation request are undone, state 422 is entered whereby the activation engine notifies the requester of the failure.

In the third case (from state 406), state 418 may also be entered directly from state 406 if one of the atomic tasks fails outright. For example, if there is a failure on a target element that does not have either a time restriction or a batch reset restriction, such a failure would cause state 418 to be entered directly from state 406. In this case, all previously completed atomic tasks are undone and the requester would be notified of the failure (state 422).

As can be appreciated from the foregoing, the use of journaling proxies and the innovative technique of intentionally withholding the execution of or delaying atomic tasks and responding with qualified acknowledgements allow the activation engine resources to be freed up rapidly in order to perform other activation tasks even when one or more of the target devices have a configuration time constraint or a batch reset constraint. Furthermore, there is no need to modify the activation engine itself, which tends to be a highly complex, off-the-shelf package and, therefore, difficult to modify and debug. Additionally, the use of the journaling proxy solves both the configuration time constraint problem and the batch reset problem with respect to the target elements, allowing the target elements to be configured at the appropriate time in the case of the configuration time constraint problem or to execute more efficiently in the case of the batch reset problem, all without requiring any change in the target elements.

While this invention has been described in terms of several embodiments, there are alterations, permutations, and equivalents which fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

1. A method of activating a plurality of target elements in a computing arrangement, comprising:
receiving a high-level activation request pertaining to said plurality of target elements;
parsing said high-level activation request into a plurality of atomic requests; and
receiving at time t1 a first atomic request of said plurality of atomic requests at a first journaling proxy, said first journaling proxy being associated with a first target element of said plurality of target elements, said first journaling proxy intentionally delaying sending said first atomic request to said first target element for execution until a time t2 that satisfies a set of predefined configuration parameters for said first target element.

2. The method of claim 1 wherein said set of predefined configuration parameters for said first target element specifies a predefined time window within which said executing said first atomic request occurs.

3. The method of claim 1 wherein said first atomic request includes resetting said first target element, said resetting only occurs after a predefined number of reset-containing requests for said first target element are accumulated by said first journaling proxy since said first target element was last reset, said resetting only occurs once at said first target element for said predefined number of reset-containing requests.

4. The method of claim 1 wherein said first atomic request includes resetting said first target element, said resetting of said first target element only occurs after an expiration of a predefined time period since said first target element was last reset.

5. The method of claim 1 wherein said first atomic request includes resetting said first target element, said resetting only occurs after an expiration of a predefined time period since said first atomic request is received by said first journaling proxy.

6. The method of claim 1 wherein said first atomic request includes resetting said first target element, said time t2 occurs responsive to a first occurrence of one of a first event and a second event, said first event representing an accumulation of a predefined number of reset-containing requests for said first target element by said first journaling proxy, said second event representing an expiration of a predefined time period since said first atomic request is received by said first journaling proxy.

7. The method of claim 1 wherein only a subset of target devices that receive atomic requests parsed from said high-level request are associated with journaling proxies.

8. The method of claim 7 wherein each target device of said subset is associated with a different journaling proxy.

9. The method of claim 1 further comprising sending a qualified success message from said first journaling proxy to said activation engine after said first atomic request is received at said first journaling proxy, said qualified success message enabling said activation engine to consider said high-level request a provisional success in order to attend to any other pending high-level activation request.

10. The method of claim 9 wherein said qualified success message is sent only after said first journaling proxy ascertains that said first target element is capable of performing all tasks specified by said first atomic request but for at least one unsatisfied parameter in said predefined configuration parameters.

11. The method of claim 1 further comprising undoing all completed atomic tasks that have been completed pursuant to said high level activation request if said first target element is unable to complete said first atomic request when said first atomic request is executed at said first target element.

12. An arrangement for activating a target element, comprising:
an activation engine; and
a journaling proxy coupled to said activation engine and said target element, said journaling proxy being configured to receive an atomic request from said activation engine at time t1, said journaling proxy intentionally delaying sending said atomic request to said target element for execution until a time t2 that satisfies a set of predefined configuration parameters for said target element.

13. The arrangement of claim 12 wherein said set of predefined configuration parameters for said target element specifies a predefined time window within which said executing said atomic request occurs.

14. The arrangement of claim 12 wherein said atomic request includes resetting said target element, said resetting only occurs after a predefined number of reset-containing requests for said target element are accumulated by said journaling proxy since said target element was last reset, said resetting only occurs once at said target element for said predefined number of reset-containing requests.

15. The arrangement of claim 12 wherein said atomic request includes resetting said target element, said resetting only occurs after an expiration of a predefined time period since said target element was last reset.

16. The arrangement of claim 12 wherein said atomic request includes resetting said target element, said resetting only occurs after an expiration of a predefined time period since said atomic request is received by said journaling proxy.

17. The arrangement of claim 12 wherein said atomic request includes resetting said target element, said time t2 occurs responsive to a first occurrence of one of a first event and a second event, said first event representing an accumulation of a predefined number of reset-containing requests for said target element by said journaling proxy, said second event representing an expiration of a predefined time period since said atomic request is received by said journaling proxy.

18. The arrangement of claim 12 wherein said journaling proxy is configured to send a qualified success message to said activation engine after said atomic request is received at said journaling proxy, said qualified success message enabling said activation engine to consider said high-level request a provisional success in order to attend to any other pending high-level activation request.

19. The arrangement of claim 18 wherein said qualified success message is sent only after said journaling proxy ascertains that said target element is capable of performing all tasks specified by said atomic request but for at least one unsatisfied parameter in said predefined configuration parameters.

20. An article of manufacture comprising a program storage medium having computer readable code embodied therein, said computer readable code being configured to activate a target element in a computing arrangement, comprising:
computer readable code for receiving an atomic request at a journaling proxy from an activation engine; and
computer readable code for intentionally delaying execution of said atomic request by said target element until a time that satisfies a set of predefined configuration parameters for said target element.

21. The article of manufacture of claim 20 wherein said set of predefined configuration parameters for said target element specifies a predefined time window within which said executing said atomic request occurs.

22. The article of manufacture of claim 20 wherein said atomic request includes resetting said target element, said computer readable code for said intentionally delaying includes computer readable code for permitting resetting of said target element only after a predefined number of reset-containing requests for said target element are received said journaling proxy since said target element was last reset, said resetting only occurs once at said target element for said predefined number of reset-containing requests.

23. The article of manufacture of claim 20 wherein said atomic request includes resetting said target element, said computer readable code for said intentionally delaying includes computer readable code for permitting resetting of said target element only after an expiration of a predefined time period since said target element was last reset.

24. The article of manufacture of claim 20 wherein said atomic request includes resetting said target element, said computer readable code for said intentionally delaying includes computer readable code for permitting resetting of said target element only after an expiration of a predefined time period since said atomic request was received by said journaling proxy.

25. The article of manufacture of claim 20 further comprising computer readable code for sending a qualified success message from said journaling proxy to said activation engine after said atomic request is received at said journaling proxy, said qualified success message enabling said activation engine to consider a high-level request that contains said atomic request a provisional success in order to attend to any other pending high-level activation request.

26. The article of manufacture of claim 25 wherein said qualified success message is sent only after said journaling proxy ascertains that said target element is capable of performing all tasks specified by said atomic request but for at least one unsatisfied parameter in said predefined configuration parameters.

27. The article of manufacture of claim 20 further comprising undoing all completed atomic tasks that have been completed pursuant to said high level activation request if said target element is unable to complete said atomic request when said atomic request is executed at said target element.
